(19) United States
(12) Patent Application Publication
(10) Pub. No.: US 2017/0068930 A1
(43) Pub. Date: Mar. 9, 2017

(54) Intermodal Luggage Tracking System and Method

(71) Applicant: Michael J. Attar, Westhampton, NY (US)

(72) Inventor: Michael J. Attar, Westhampton, NY (US)

(21) Appl. No.: 15/354,814

(22) Filed: Nov. 17, 2016

Related U.S. Application Data
(63) Continuation-in-part of application No. 14/092,615, filed on Nov. 27, 2013.
Application No. 14/092,615 is a continuation-in-part of application No. 15/013,910, filed on Feb. 2, 2016.
Application No. 15/013,910 is a continuation-in-part of application No. 15/189,651, filed on Jun. 22, 2016.
(60) Provisional application No. 61/825,301, filed on May 20, 2013.
(60) Provisional application No. 62/110,987, filed on Feb. 2, 2015.

(51) Int. Cl. G06Q 10/08; B64F 1/36; G06K 19/077; G06K 19/06; G06K 7/14

(52) U.S. Cl. CPC G06Q 10/087; G06K 19/06028; G06K 7/1413; G06K 19/07758; B64F 1/368

(57) ABSTRACT

A luggage tracking and routing method which is compatible with different luggage handling systems and provides a user with tracking data during travel. The method includes receiving boarding pass data through a dispensing kiosk from a plurality of service kiosks. The boarding pass data is then programmed onto an electronic tracking tag, and the electronic tracking tag is dispensed to be attached to a piece of luggage. The electronic tracking tag broadcasts a routing identifier from the boarding pass data with the electronic tracking tag. A plurality of luggage detection devices is used to track and monitor the electronic tracking tag. Tracking data is compiled with a remote server from each detection instance of the electronic tracking tag. The tracking data is then displayed to user with a user computing device. Finally, the electronic tracking tag is submitted to be refurbished by a reclaiming kiosk from services kiosks.

### FIELD OF THE INVENTION

The present invention relates generally to systems and methods for tracking passenger luggage during intermodal travel, such as aircraft, trains or ships. More specifically, the present invention is a luggage tracking system and method which provides each passenger with real-time information regarding the specific location and status of his or her luggage. This is accomplished through a multi-modal and multi-frequency electronic tracking tag which allows for luggage tracking and routing throughout a multitude of luggage handling systems and transportation services.

### BACKGROUND OF THE INVENTION

In the past decade, the number of passengers flying has increased over 50 percent. An increase in passengers means an increase in the volume of luggage being managed and handled by the airport, the luggage handling system of the airport to be more specific. While the industry is continuously upgrading the technology and methods used to handle luggage, a significant percentage of luggage is still mishandled, lost, damaged, pilfered, delayed, or stolen. Two of the main reasons for delayed luggage is transfer mishandling and ticketing errors in between different flights, airports, and airlines. This is due to the fact that different airports use different luggage handling systems, thus causing errors at the interface between different systems. More specifically, currently there are two main luggage handling systems, a standard optical identification system and a wireless identification system. The standard optical identification system uses barcodes and barcode scanners to tag and route luggage through the airport. The wireless identification system uses radio frequency identification (RFID) technology in order to tag and route luggage through the airport. There is need for a system and method which efficiently and effectively integrates the two luggage handling systems, issues and tracks luggage tags, and provides the capability to store additional data about the luggage on the tag.

The present invention is a luggage tagging system and method that is compatible with both types of luggage handling systems. The present invention is ideal for tracking luggage for intermodal travel where a multitude of handling systems are involved. Additionally, the present invention provides passengers with the ability to individually tag and track their luggage with their smartphones. This is achieved through a self-service dispenser of reusable, multi-modal, multi-frequency electronic tracking tags. These multi-frequency tags provide the capability to include additional data on the tag which enables multi-modal handling, routing and other value added services. The present invention may be implemented in a variety of fields including, but not limited to, aviation, ground transportation, and other similar transportation.

### BRIEF DESCRIPTION OF THE DRAWINGS

FIG. 1 is a system diagram of the present invention.

FIG. 2 is a flowchart depicting the overall process of the present invention.

FIG. 3 is a flowchart depicting the steps necessary to compile tracking data using the plurality of luggage detection devices.

FIG. 4 is a flowchart depicting the steps necessary to wirelessly receive the routing identifier by the arbitrary detection device, within the overall process of the present invention.

FIG. 5 is a flowchart depicting the steps necessary to graphically display and scan the routing identifier from the display screen of the electronic tracking tag, within the overall process of the present invention.

FIG. 6 is a flowchart depicting the steps necessary to broadcast the plurality of routing identifiers through the broadcasting frequency of the corresponding service, within the overall process of the present invention.

FIG. 7 is a flowchart depicting the steps necessary to store the tracking data on the remote server and on the electronic tracking tag, within the overall process of the present invention.

FIG. 8 is a flowchart depicting the steps necessary to determine the status of the piece of luggage based on the location of the electronic tracking tag.

FIG. 9 is a flowchart depicting the steps necessary to refurbish the electronic tracking tag.

### DETAIL DESCRIPTIONS OF THE INVENTION

All illustrations of the drawings are for the purpose of describing selected versions of the present invention and are not intended to limit the scope of the present invention.

The present invention is a luggage tracking system and method. The present invention provides real-time tracking data to each passenger regarding his or her luggage. More specifically, the present invention is a self-service process in which passengers can use their smartphones and other similar devices to tag and track their luggage for intermodal travel. This is accomplished through the use of a multi-modal and multi-frequency electronic tracking tag that is compatible with different luggage handling systems. As a result, the present invention may be implemented in a variety of fields including, but not limited to, aviation, ground transportation, and other similar transportation.

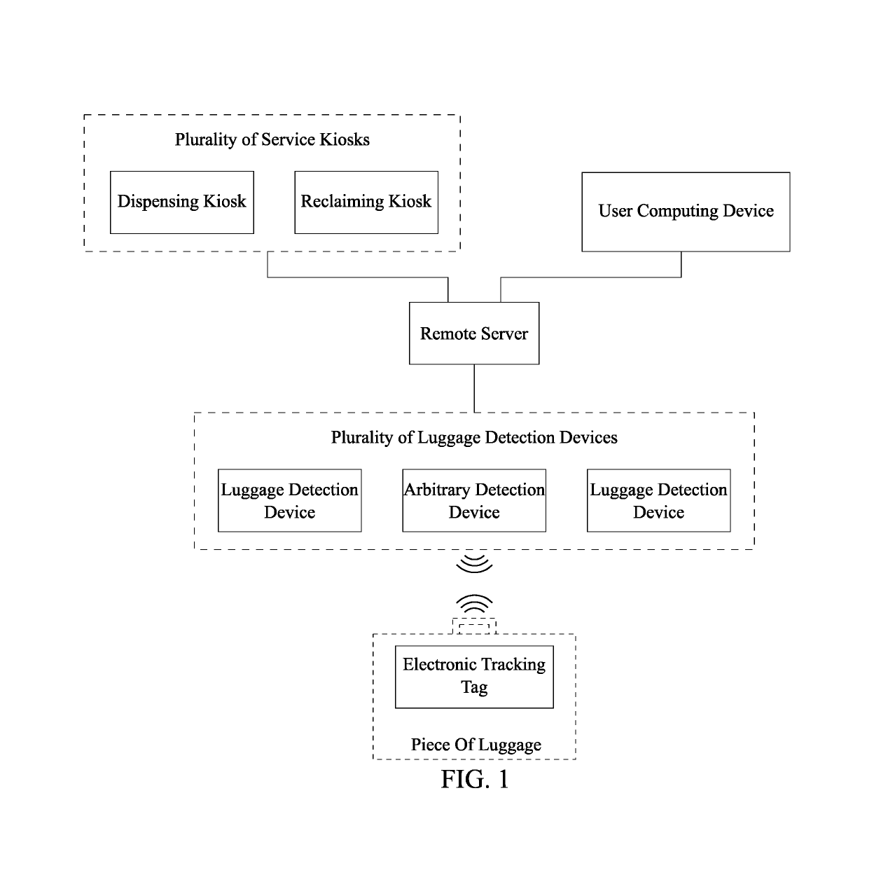

The present invention comprises a system and a method that provide a novel means for tracking and routing luggage within a baggage handling system or a multitude of baggage handling systems. Referring to FIG. 1, the system comprises the physical components necessary to execute the method of the present invention. In particular, the system comprises a plurality of service kiosks, a remote server, and an at least one electronic tracking tag (Step A). The service kiosks disperse and reclaim the electronic tracking tag(s) and may act as the interface between a passenger and the present invention. In the preferred embodiment of the present invention, the plurality of service kiosks includes two types of kiosks, a dispersing kiosk and a reclaiming kiosk. The dispersing kiosk is used for registration purposes. Additionally, the dispersing kiosk physically stores and dispenses the electronic tracking tag. The reclaiming kiosk receives and refurbishes electronic tracking tags. The service kiosks may be implemented at various bag drop off locations such as airports, train stations, cruise ship terminals, and special secure drop off points in a bank or post office. The remote server manages data relating to the user and his or her luggage; the user's luggage is managed through the electronic tracking tag. In order to achieve this, the services kiosks are communicably coupled to the remote server (Step A).

The electronic tracking tag is a reusable and programmable electronic device that may easily be attached and detached to a baggage of the passenger. A variety of means may be used to fasten electronic tracking tag to the baggage including, but not limited to, hook-and-loop fasteners, strings, double-sided adhesive tapes, bolts, and other similar fastening mechanisms. The electronic tracking tag is capable of wireless communication and may also comprise a display screen and or a data storage device. The wireless communication capability allows the electronic tracking tag to transmit and receive data over separate wireless frequencies. As a result, the electronic tracking tag may be programmed by the plurality of service kiosks and detected and/or programmed by the plurality of luggage detection devices. Furthermore, this ensures that the electronic tracking tag complies with the needs and standards of a radio frequency based luggage handling system, a system where a wireless connection is used to identify and track passenger bags. The display screen allows the electronic tracking tag to display a barcode in order to comply with and be used by an optical-based luggage handling system, a system where an optical scanner and a barcode are used to identify and track passenger bags. The data storage device allows the electronic tracking device to store information directly on the electronic tracking tag.

The plurality of luggage detection devices senses and registers the electronic tracking tag at different locations. The plurality of luggage detection devices is communicably coupled to the remote server in order to transmit tracking information to the remote server and therefore the passenger (Step B). Each of the plurality of luggage detection devices is associated with a zone location, a physical location of the corresponding detection device. In one embodiment, each of the luggage detection devices includes a wireless communication device that is used to scan, identify, and program data to the electronic tracking tag. In another embodiment of the present invention, each of the luggage detection devices includes a barcode sensor that is used to physically scan a barcode that is graphically displayed by the display screen of the electronic tracking tag. In the preferred embodiment, the luggage detection devices are the detection devices/methods of existing baggage handling systems. For example, baggage handling systems for airports currently use scanners and, in some cases, wireless devices to receive and route baggage efficiently through airports and airplanes. Additionally, each of the luggage detection devices includes both the wireless communication device and the barcode sensor such that the electronic tracking tag is compatible with multitude of detection devices. The remote server can also send data to any of the plurality of the luggage detection devices to program data onto the electronic tracking tag.

The overall process of the present invention is described in relation to a single passenger utilizing the present invention, wherein the passenger is referenced as a user and is furthermore associated with a user account. For simplicity purposes, the user only has a single bag. This does not limit the scope of the present invention as the process may be implemented, and is designed, for a plurality of users, wherein each of the user accounts may submit and track a multitude of bags. The remote server receives, manages, and distributes data relating to the user(s), user account(s), and the luggage of the user account, i.e. the electronic tracking tag(s); essentially, the remote server manages and maintains a tracking database.

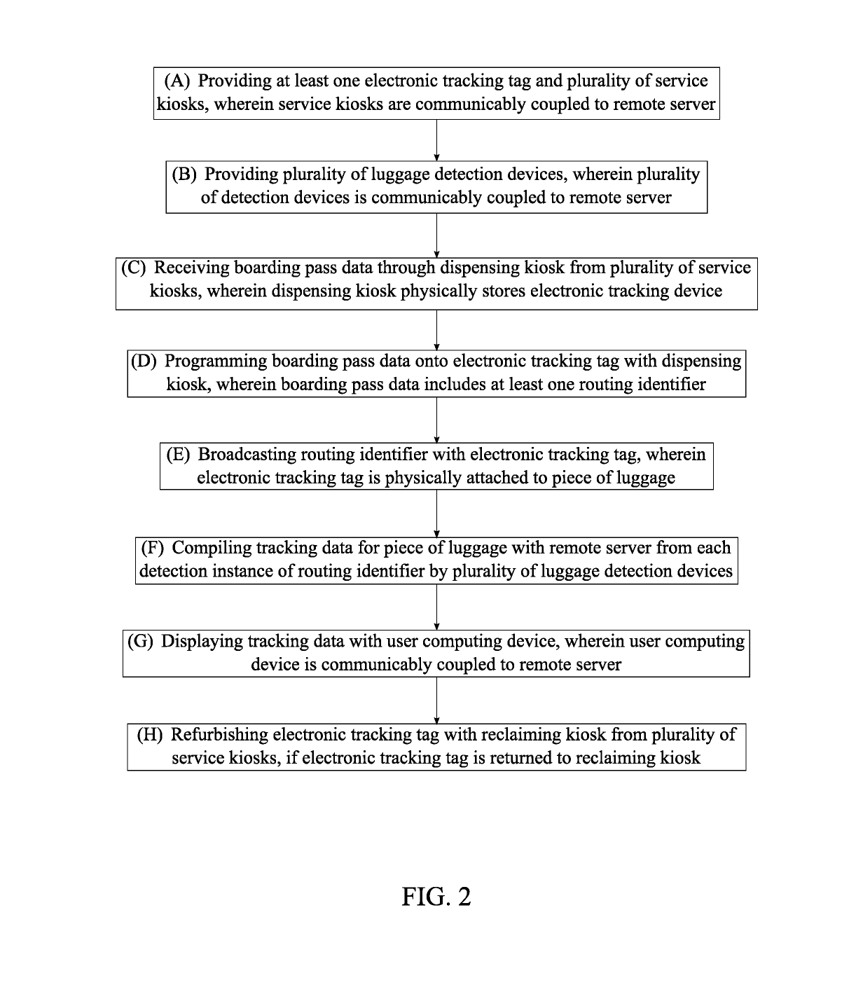

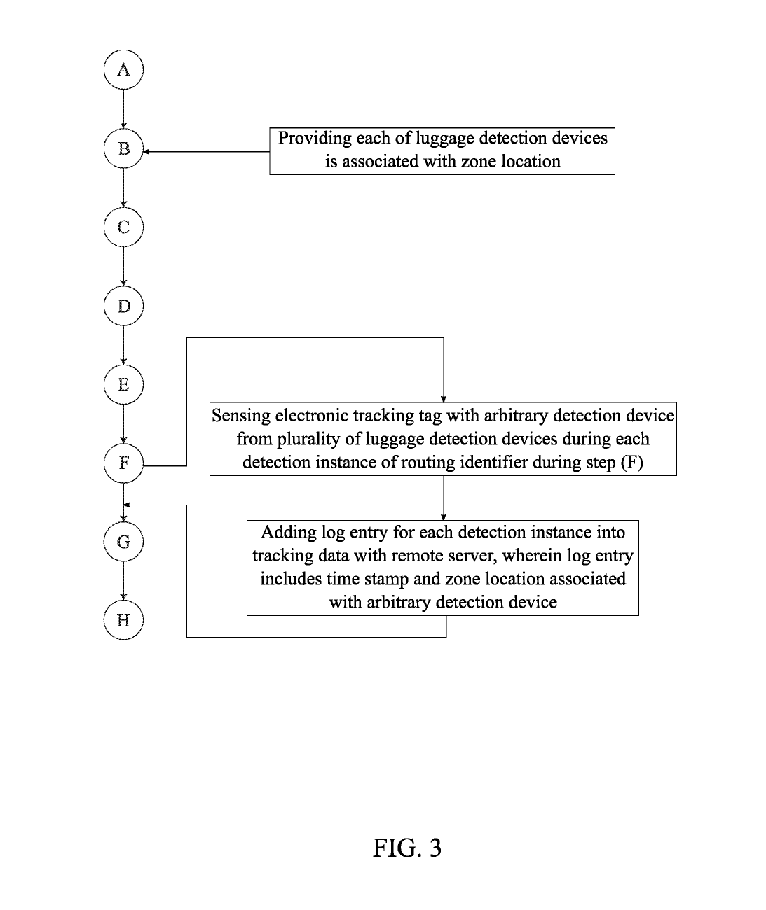

Referring to FIG. 2, the overall process of the present invention begins with the dispensing kiosk receiving boarding pass data from the user (Step C). The boarding pass data may include, but is not limited to, the passenger name, passenger biometrics, passenger email, passenger smartphone number, passenger photo, luggage description, number of bags, a departure location, a destination location, routing identifier for luggage, vehicle number, and other pertinent information regarding the passenger's travel plans. The boarding pass data may be submitted to the dispensing kiosk through a variety of means. One method includes the user optically scanning his or her ticket with the dispensing kiosk in order to submit the boarding pass data. Another method includes the user wirelessly connecting to the dispersing kiosk and electronically submitting the boarding pass data with a user computing device, for example a smartphone or a tablet. The boarding pass data is then used to identify and validate the passenger. Next, the dispersing kiosk programs the boarding pass data and any other relevant information onto the electronic tracking tag, the data storage device to be more specific, and dispenses the electronic tracking tag (Step D). The user then attaches the electronic tracking tag to a piece of luggage that is being checked in. One of the most important pieces of information programmed onto the electronic tracking tag is the routing identifier. The routing identifier is used for authorization and route message generation which is relayed to and used by the baggage handling system, i.e. the plurality of luggage detection devices. Continuing the process, the routing identified is broadcasted with the electronic tracking tag on an at least one frequency (Step E). The piece of luggage is then submitted to the luggage handling system for processing. As the piece of luggage is transported and routed amongst different locations, tracking data is compiled for the piece of luggage with the remote server. Tracking data is compiled from each detection instance of the routing identifier by the plurality of luggage detection devices (Step F). Referring to FIG. 3, during each detection instance of the routing identifier, an arbitrary detection device from the plurality of luggage detection device senses, registers, or scans the electronic tracking tag. The arbitrary detection device stands for any device from the plurality of luggage detection devices. As a result, a log entry for each detection instance is added to the tracking data with the remote server, wherein the log entry includes a time stamp and the zone location associated with the arbitrary detection device. Additional information that may be included in the log entry are the luggage routing number, tracking progress, battery status, and other pertinent information. Supplemental data like security scans or transfer of ownership event may be written directly onto the electronic tracking tag. This data can originate either local or via the central tracking server.

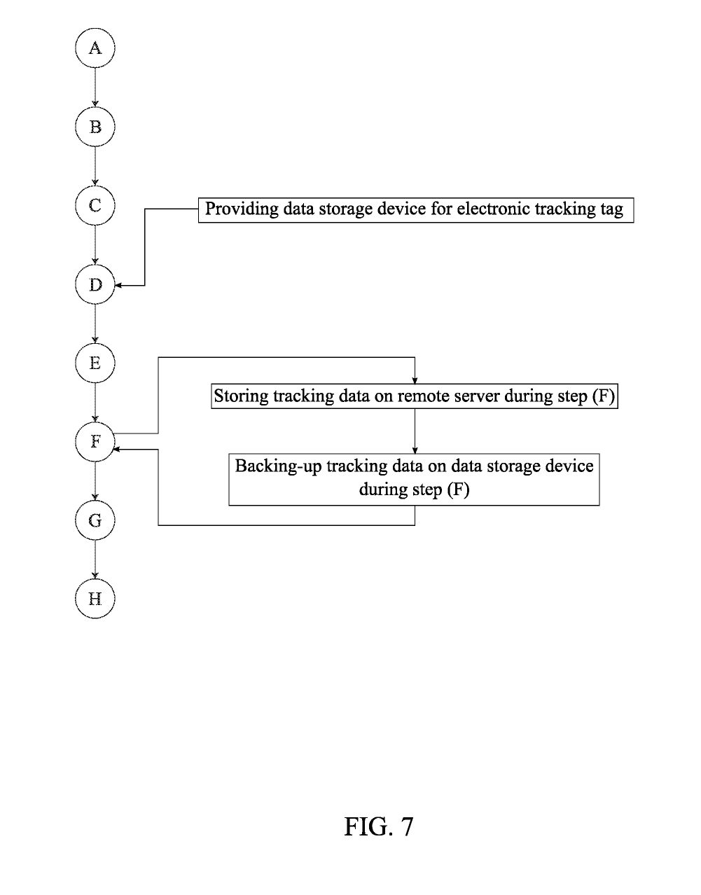

As the tracking data is compiled, the tracking data is displayed to the user with the user computing device (Step G). As a result, the tracking data is real-time data. Type of devices that may be used as the user computing device include, but are not limited to, smartphones, laptops, tablets, and other similar computing devices. The tracking data includes a plurality of log entries and may be displayed in a variety of means. It is preferred that the tracking data is displayed in a chronological order. The tracking data is stored on the remote server and backed up on the data storage device of the electronic tracking tag during Step F as seen in FIG. 7. This allows for data to be extracted from the electronic tracking tag. Finally, when the piece of luggage arrives at the destination location, the electronic tracking tag is returned and refurbished. From the perspective of the present invention, if the electronic tracking tag is returned to the reclaiming kiosk, then the reclaiming kiosk refurbishes the electronic tracking tag in order to be reused (Step H).

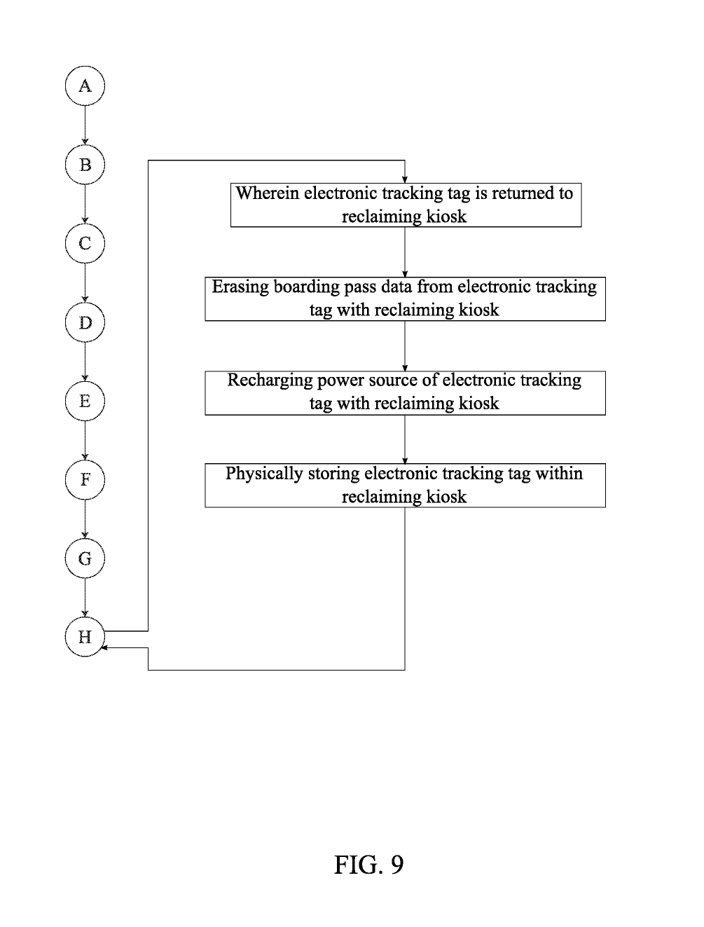

Referring to FIG. 9, when the electronic tracking tag is returned to the reclaiming kiosk, a refurbishing process is initiated. First, any optional events written on the electronic tracking tag are stored by the remote server for archival storage. Next, with the except of the unique identifier of the electronic tracking tag, all data is erased from the electronic tracking tag by with the reclaiming kiosk. Simultaneously, the electronic tracking tag is marked as returned by the remote server. Next, a power source of the electronic tracking tag is recharged with the reclaiming kiosk. In certain cases, the electronic tracking tag is also cleaned and repaired if damaged. Finally, the electronic tracking tag is physically stored within the reclaiming kiosk. In one embodiment of the present invention, the features and capabilities of the dispersing kiosk and the reclaiming kiosk are implemented in a single service kiosk, therefore increasing the efficiency of the present invention.

In one embodiment of the present invention, the electronic tracking tag is scanned by arbitrary detection device through a wireless connection between the two components. In this embodiment, each of the luggage detection devices includes the wireless communication device. The wireless communication device allows for wireless communication between the plurality of luggage detection devices and the electronic tracking tag. More specifically, when the electronic tracking tag comes within a predetermined radius of the wireless communication device, the electronic signal, i.e. the routing identifier, is received with the wireless communication device of the arbitrary detection device. In relation to the overall process, this occurs during Step J.

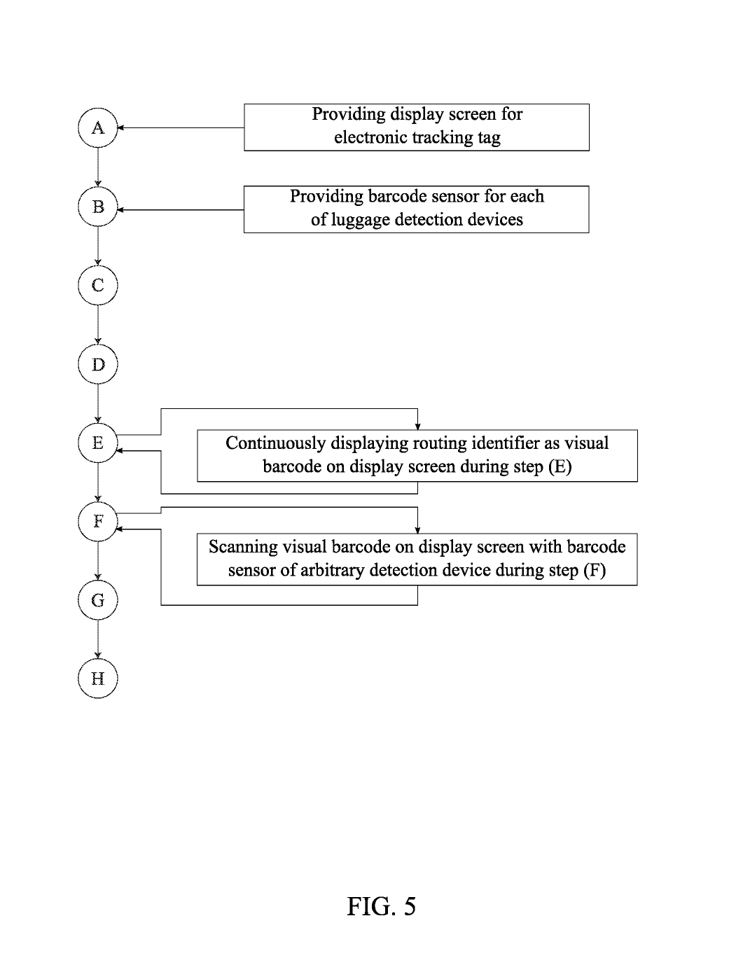

In another embodiment, the present invention utilizes standard barcode technology to scan the electronic tracking tag as seen in FIG. 5. In this embodiment, each of the luggage detection devices includes the barcode sensor. Additionally, the electronic tracking tag includes the display screen. The display screen allows the electronic tracking tag to continuously display the routing identifier as a visual barcode during Step E. In relation to overall process of the present invention, during Step J, the detection instance includes the visual barcode being scanned with the barcode sensor of the arbitrary detection device. The display screen may also be used to display portions of the boarding pass data so that the piece of luggage is more easily identified by passengers/users.

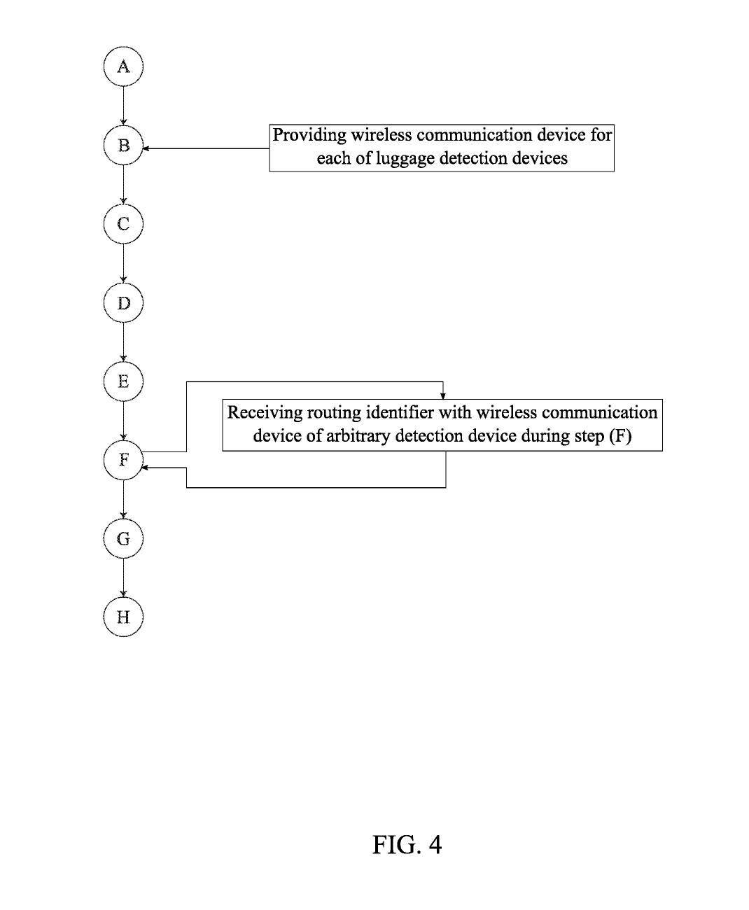

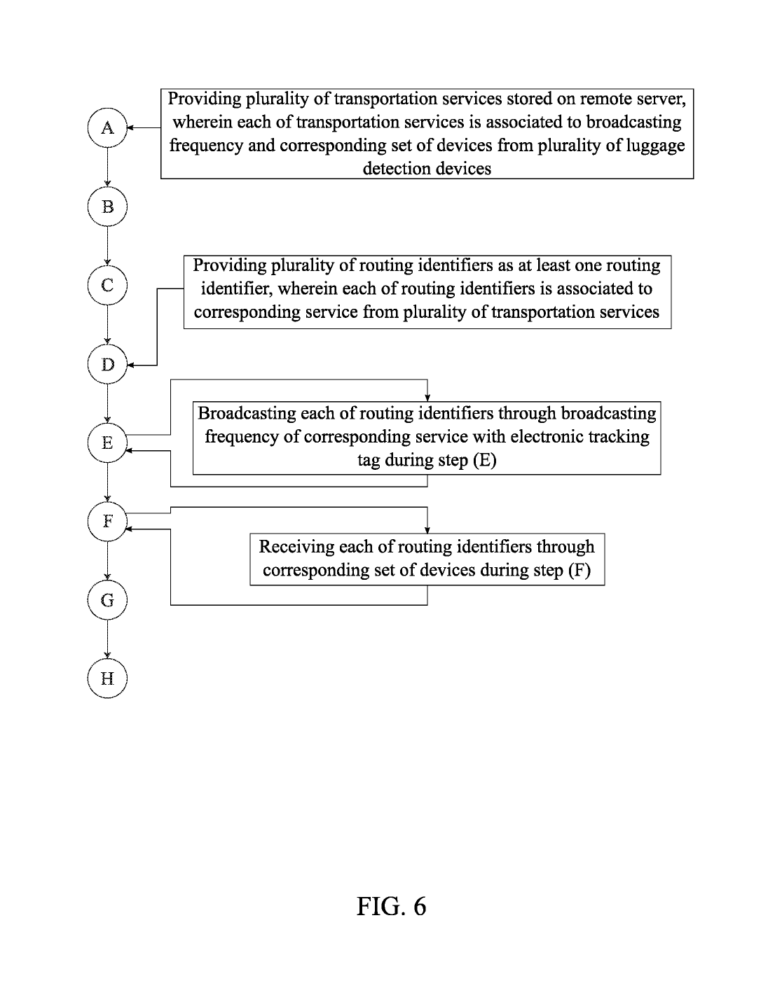

Referring to FIG. 6, one of the main benefits of the present invention is that the electronic tracking tag may be used by a multitude of different transportation services as well as a multitude of different baggage handling systems, yielding a luggage tracking system ideal for intermodal use. For example, the piece of luggage may be routed and tracked through airport services and train services even if the services utilize different luggage handling systems with variable detection devices, i.e. barcode-based or wireless-based. This is achieved through the electronic tracking tag's ability to broadcast a multitude of routing identifiers at different frequencies. In one embodiment of the present invention, a plurality of transportation services is stored on the remote server, wherein each of the transportation services is associated to a broadcasting frequency and a corresponding set of devices from the plurality of luggage detection devices. Additionally, the boarding data includes a plurality of routing identifiers, wherein each of the routing identifiers is associated to a corresponding service from the plurality of transportation services. The present invention allows the electronic tracking tag to be routed and tracked through the plurality of transportation services by having the electronic tracking tag broadcast each of the identifiers through the broadcasting frequency of the corresponding service during Step E. As a result, each of the routing identifiers is received through the corresponding set of devices during Step F as seen in FIG. 4.

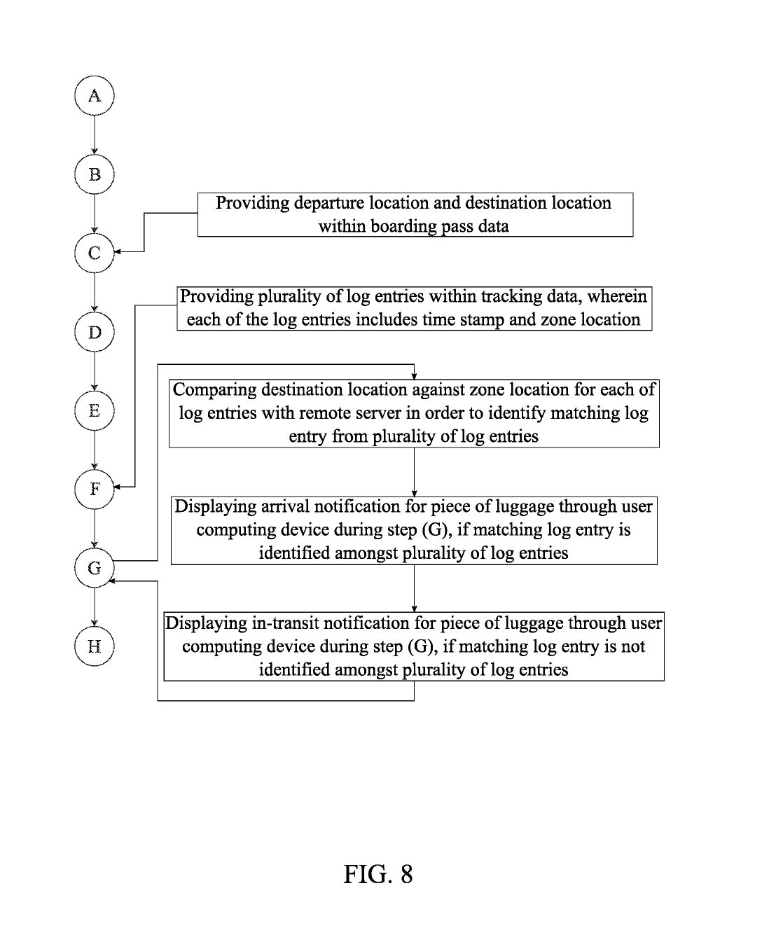

Referring to FIG. 8, the present invention provides the user account additional information regarding the status and location of the electronic tracking tag. More specifically, during Step G, the remote server compares the destination location against the zone location for each log entry from the tracking data in order to identify a matching log entry. If the matching log entry is identified, then an arrived status for the piece of luggage is displayed to the user account through the user computing device during Step G. Alternatively, if the matching log entry is not identified, then an in-transit status for the piece of luggage is displayed to the user account through the user computing device during Step G. The status of the piece of luggage may be displayed to the user account per request from the user account. This information may be sent as a push notification to the user computing device. Additionally, this information may be produced based on a user request being received by the user computing device. This may be achieved through a software application installed onto the user computing device. In one embodiment, the status of the piece of luggage may be sent to the user account through an email address associated with the user account or through a mobile telephone associated with the user account.

In the preferred embodiment, the present invention is executed for a plurality of user accounts and a plurality of electronic tracking tags, wherein each of the user accounts is associated with at least one electronic tracking tag. In other words, the present invention is designed to be utilized by a multitude of people where each person may use more than one electronic tracking tag.

Although the invention has been explained in relation to its preferred embodiment, it is to be understood that many other possible modifications and variations can be made without departing from the spirit and scope of the invention as hereinafter claimed.

What is claimed is:

1. A method for tracking luggage through intermodal transportation services comprises the steps of:
(A) providing an at least one electronic tracking tag and a plurality of service kiosks, wherein the service kiosks are communicably coupled to a remote server;
(B) providing a plurality of luggage detection devices, wherein the plurality of detection devices is communicably coupled to the remote server;
(C) receiving boarding pass data through a dispensing kiosk from the plurality of service kiosks, wherein the dispensing kiosk physically stores the electronic tracking device;
(D) programming the boarding pass data onto the electronic tracking tag with the dispensing kiosk, wherein the boarding pass data includes at least one routing identifier;
(E) broadcasting the routing identifier with the electronic tracking tag, wherein the electronic tracking tag is physically attached to a piece of luggage;
(F) compiling tracking data for the piece of luggage with the remote server from each detection instance of the routing identifier by the plurality of luggage detection devices;
(G) displaying the tracking data with a user computing device, wherein the user computing device is communicably coupled to the remote server; and
(H) refurbishing the electronic tracking tag with a reclaiming kiosk from the plurality of service kiosks, if the electronic tracking tag is returned to the reclaiming kiosk.

2. The method for tracking luggage through intermodal transportation services as claimed in claim 1 comprises the steps of:
providing each of the luggage detection devices is associated with a zone location;
sensing the electronic tracking tag with an arbitrary detection device from the plurality of luggage detection devices during each detection instance of the routing identifier during step (F); and
adding a log entry for each detection instance into the tracking data with the remote server, wherein the log entry includes a time stamp and the zone location associated with the arbitrary detection device.

3. The method for tracking luggage through intermodal transportation services as claimed in claim 2, comprises the steps of:
providing a wireless communication device for each of the luggage detection devices; and
receiving the routing identifier with the wireless communication device of the arbitrary detection device during step (J).

4. The method for tracking luggage through intermodal transportation services as claimed in claim 2 comprises the steps of:
providing a barcode sensor for each of the luggage detection devices;
providing a display screen for the electronic tracking tag;
continuously displaying the routing identifier as a visual barcode on the display screen during step (E); and
scanning the visual barcode on the display screen with the barcode sensor of the arbitrary detection device during step (J).

5. The method for tracking luggage through intermodal transportation services as claimed in claim 2, comprises the steps of:
providing a plurality of transportation services stored on the remote server, wherein each of the transportation services is associated to a broadcasting frequency and a corresponding set of devices from the plurality of luggage detection devices;
providing a plurality of routing identifiers as the at least one routing identifier, wherein each of the routing identifiers is associated to a corresponding service from the plurality of transportation services;
broadcasting each of the routing identifiers through the broadcasting frequency of the corresponding service with the electronic tracking tag during step (E); and
receiving each of the routing identifiers through the corresponding set of devices during step (F).

6. The method for tracking luggage through intermodal transportation services as claimed in claim 1 comprises the steps of:
wherein the electronic tracking tag is returned to the reclaiming kiosk;
erasing the boarding pass data from the electronic tracking tag with the reclaiming kiosk;
recharging a power source of the electronic tracking tag with the reclaiming kiosk; and
physically storing the electronic tracking tag within the reclaiming kiosk.

7. The method for tracking luggage through intermodal transportation services as claimed in claim 2 comprises the steps of:
providing a data storage device for the electronic tracking tag;
storing the tracking data on the remote server during step (F); and
backing-up the tracking data on the data storage device during step (F).

8. The method for tracking luggage through intermodal transportation services as claimed in claim 1 comprises the steps of:
providing a departure location and a destination location within the boarding pass data;
providing a plurality of log entries within the tracking data, wherein each of the log entries includes a time stamp and a zone location;
comparing the destination location against the zone location for each of the log entries with the remote server in order to identify a matching log entry from the plurality of log entries;
displaying an arrival notification for the piece of luggage through the user computing device during step (G),
if the matching log entry is identified amongst the plurality of log entries; and
displaying an in-transit notification for the piece of luggage through the user computing device during step (G),
if the matching log entry is not identified amongst the plurality of log entries.
